(19) United States
(12) Patent Application Publication
(10) Pub. No.: US 2026/0204501 A1
(43) Pub. Date: Jul. 16, 2026

(54) REED SWITCH UNIT

(71) Applicant: SUMITOMO WIRING SYSTEMS, LTD., Mie (JP)

(72) Inventor: Ryuichi FUJISAKI, Mie (JP)

(21) Appl. No.: 19/134,748

(22) PCT Filed: Nov. 21, 2023
(86) PCT No.: PCT/JP2023/041812

§ 371 Date: Jun. 2, 2025

(30) Foreign Application Priority Data
Dec. 6, 2022 (JP) 2022-194724

(51) Int. Cl. H01H 35/18

(52) U.S. Cl. CPC H01H 35/18

(57) ABSTRACT

A reed switch unit (11) comprises: an elongate reed switch sub-unit (21) which includes a reed switch (25) and which has, in a length direction, a first end portion (26) and a second end portion (27); and a cylindrical housing (22) which has a first opening portion (32) into which the reed switch sub-unit (21) can be inserted from the first end portion (26) side, and which accommodates and holds the reed switch sub-unit (21). The second end portion (27) of the reed switch sub-unit (21) is supported on the first opening portion (32) side by the housing (22). The housing (22) has a second opening portion (33) on the opposite side to the first opening portion (32). The reed switch unit (11) is provided with a rubber member (23) that is fitted into the second opening portion (33) to stop water, and that supports the first end portion (26) of the reed switch sub-unit (21).

### TECHNICAL FIELD

The present disclosure relates to a reed switch unit.

### BACKGROUND

Conventionally, some reed switch units are provided in a liquid reservoir tank (see, for example, Patent Document 1). This reed switch unit is provided with a tubular housing integrally provided on the reservoir tank and an elongated reed switch subunit to be accommodated and held in the housing. The reed switch subunit includes a reed switch and has a first end part and a second end part in a length direction. The reed switch subunit is inserted in a horizontal direction into an opening of the housing with the first end part thereof in the lead, and the second end part of the reed switch unit is supported on the opening side of the housing in the housing. A float including a permanent magnet and floating on the liquid is accommodated in the reservoir tank. For example, when the permanent magnet of the float approaches the reed switch by the float vertically moving according to a liquid level, the reed switch electrically connects two terminals. For example, a controller connected to those two terminals can detect a reduction of the liquid.

### PRIOR ART DOCUMENT

### Patent Document

Patent Document 1: International Publication No. WO 2010/035907 A1

### SUMMARY OF THE INVENTION

### Problems to be Solved

However, in the reed switch unit as described above, the second end part of the reed switch subunit is supported on the opening side of the housing in the housing, but the first end part of the reed switch subunit tends to rattle in the housing. That is, since the first end part of the reed switch subunit is a part to be inserted to the back of the housing through the opening of the housing, it has been necessary to set a tiny clearance between the first end part of the reed switch subunit and the housing in manufacturing. That clearance might allow the rattling of the first end part in the housing. This rattling causes, for example, a reduction in detection accuracy by the reed switch. For example, this causes such erroneous determination of the controller to determine that the amount of the liquid has exceeded a threshold value in a state before the amount of the liquid exceeds the threshold value.

The present disclosure aims to provide a reed switch unit enabling an improvement in detection accuracy.

### Means to Solve the Problem

The present disclosure is directed to a reed switch unit with an elongated reed switch subunit including a reed switch and having a first end part and a second end part in a length direction and a tubular housing including a first opening, the reed switch subunit being insertable into the first opening with the first end part side in the lead, the housing accommodating and holding the reed switch subunit, the second end part side of the reed switch subunit being supported on the first opening side in the housing, the housing including a second opening on a side opposite to the first opening, and the reed switch unit being provided with a rubber member for stopping water at the second opening by being fit into the second opening, the rubber member supporting the first end part of the reed switch subunit.

### Effect of the Invention

According to the reed switch unit of the present disclosure, detection accuracy can be improved.

### BRIEF DESCRIPTION OF THE DRAWINGS

FIG. 1 is a schematic side view of a reservoir tank in one embodiment.

FIG. 2 is a perspective view of a reed switch unit in the embodiment.

FIG. 3 is an exploded perspective view of the reed switch unit in the embodiment.

FIG. 4 is a plan view of a reed switch subunit and a rubber member in the embodiment.

FIG. 5 is a partial section of the reed switch unit in the embodiment.

FIG. 6 is a partial section of the reed switch unit in the embodiment.

### DETAILED DESCRIPTION TO EXECUTE THE INVENTION

### Description of Embodiments of Present Disclosure

First, embodiments of the present disclosure are listed and described.
[1] The reed switch unit of the present disclosure is provided with an elongated reed switch subunit including a reed switch and having a first end part and a second end part in a length direction and a tubular housing including a first opening, the reed switch subunit being insertable into the first opening with the first end part side in the lead, the housing accommodating and holding the reed switch subunit, the second end part side of the reed switch subunit being supported on the first opening side in the housing, the housing including a second opening on a side opposite to the first opening, and the reed switch unit being provided with a rubber member for stopping water at the second opening by being fit into the second opening, the rubber member supporting the first end part of the reed switch subunit.

According to this configuration, the second end part side of the reed switch subunit is supported on the first opening side in the housing, and the first end part thereof is supported by the rubber member fit into the second opening. Thus, the rattling of the reed switch together with the reed switch subunit with respect to the housing is suppressed. In this way, for example, the reed switch unit can detect a change of a magnetic field such as an approach of a permanent magnet with high accuracy. Further, since water is stopped at the second opening by the rubber member, the reed switch subunit is prevented from being wetted with water. Further, since the rubber member, i.e. one member, has a function of supporting the first end part of the reed switch subunit and a function of stopping water at the second opening, an increase in the number of components is, for example, suppressed.

[2] In [1] described above, the first end part may include a supporting protrusion projecting in the length direction of the reed switch subunit, and the rubber member may include a supporting recess, the supporting protrusion being fit into the supporting recess.

According to this configuration, since the first end part includes the supporting protrusion projecting in the length direction of the reed switch subunit and the rubber member includes the supporting recess, into which the supporting protrusion is fit, the rattling of the first end part in a direction intersecting the length direction of the reed switch subunit is satisfactorily supped.

[3] In [2] described above, the supporting protrusion may have a cylindrical shape.

According to this configuration, since the supporting protrusion has a cylindrical shape, the rattling of the first end part in all directions intersecting the length direction of the reed switch subunit is satisfactorily suppressed. That is, since having a cylindrical shape, the supporting protrusion can be supported in the supporting recess of the rubber member equally in all the directions intersecting the length direction of the reed switch subunit, wherefore rattling in all the directions is satisfactorily suppressed.

[4] In any one of [1] to [3] described above, the rubber member may include a plurality of projecting portions in the length direction of the reed switch subunit for locally pressing and contacting the second opening.

According to this configuration, since the rubber member includes the plurality of projecting portions in the length direction of the reed switch subunit for locally pressing and contacting the second opening, the mountability of the rubber member into the second opening is improved and the water stopping property of the second opening is improved. That is, if the rubber member is, for example, shaped to press and contact the second opening by one continuous surface, friction resistance in fitting the rubber member into the second opening increases or there is a possibility that the water stopping property cannot be maintained due to partial distortion or the like. However, these can be avoided.

[5] In [4] described above, the second opening may have a rectangular shape longer in a width direction than in a height direction when viewed from an opening direction of the second opening, the rubber member may have a rectangular shape longer in the width direction than in the height direction when viewed from the opening direction of the second opening, and the projecting portions may be provided on both surfaces in the height direction of the rubber member and provided over the entire rubber member in the width direction.

According to this configuration, since the projecting portions are provided on the both surfaces in the height direction of the rubber member and provided in the width direction over the entire rubber member longer in the width direction than in the height direction, the mountability of the rubber member into the second opening is more improved and the water stopping property of the second opening is more improved. That is, better effects can be obtained as compared to a configuration in which the projecting portions are provided on both surfaces in the width direction of the rubber member and provided in the height direction over the entire rubber member shorter in the height direction than in the width direction.

[6] In any one of [1] to [5] described above, a cover may be provided which hinders detachment of the rubber member from the second opening.

According to this configuration, since the cover for hindering the detachment of the rubber member from the second opening is provided, the detachment of the rubber member fit in the second opening, for example, due to vibration or the like is hindered.

### DETAILS OF EMBODIMENT OF PRESENT DISCLOSURE

A reed switch unit 11 according to one embodiment of the present disclosure is described below with reference to the drawings. For the convenience of description, some components may be shown in an exaggerated or simplified manner in each drawing. Further, a dimension ratio of each part may be different in each drawing. “Parallel”, “orthogonal” and “true circular” in this specification mean not only strictly parallel, orthogonal and true circular, but also substantially orthogonal, parallel and true circular within a range in which functions and effects in this embodiment are achieved. Note that the present invention is not limited to these illustrations, but is represented by claims and intended to include all changes in the scope of claims and in the meaning and scope of equivalents.

### (Configuration of Reed Switch Unit 11)

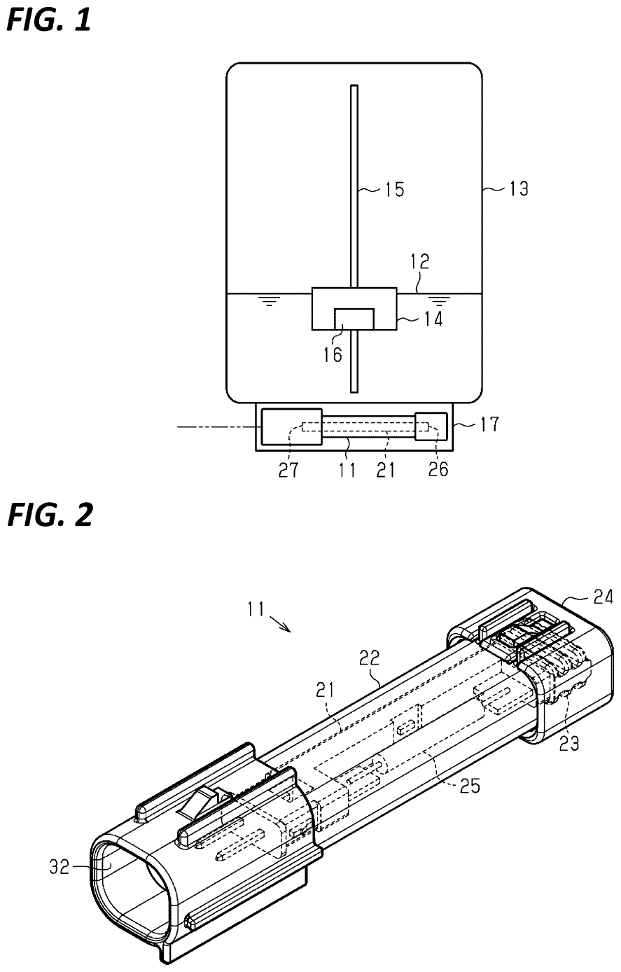

As shown in FIG. 1, the reed switch unit 11 is provided on a reservoir tank 13 capable of storing a liquid 12 such as a coolant. The reservoir tank 13 includes a float 14 inside. The float 14 is, for example, vertically movable along a rail 15 formed in the reservoir tank 13 and configured to float on the liquid 12. Further, the float 14 includes a permanent magnet 16. Further, the reservoir tank 13 of this embodiment includes a unit holding portion 17 for holding the reed switch unit 11 at the bottom. The reed switch unit 11 is held in the unit holding portion 17. The reed switch unit 11 is for detecting the amount of the liquid 12 stored in the reservoir tank 13 according to the position of the permanent magnet 16.

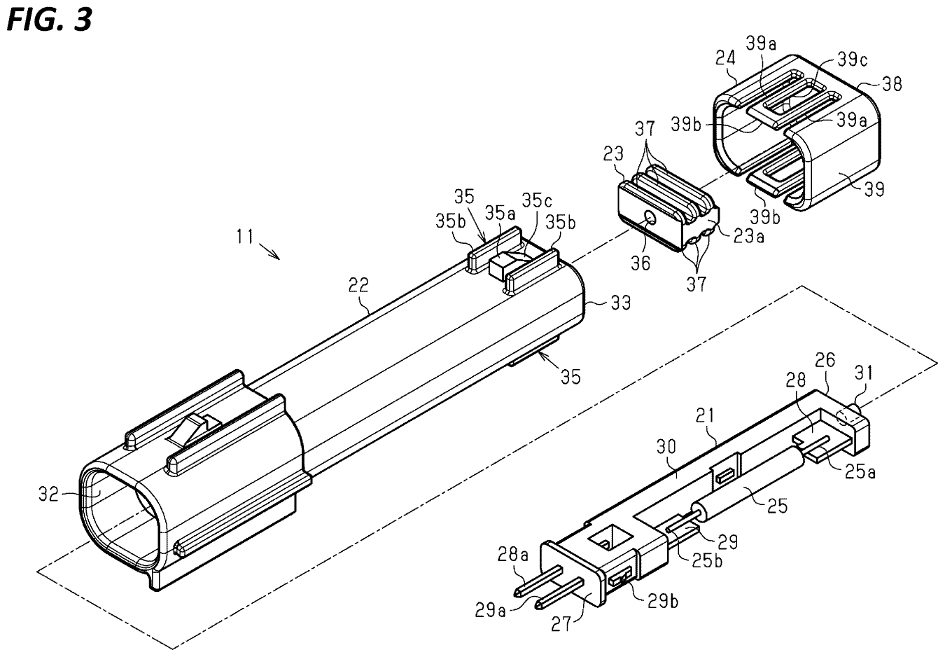

As shown in FIGS. 2 and 3, the reed switch unit 11 is formed into an elongated shape as a whole. The reed switch unit 11 is provided with an elongated reed switch subunit 21, a tubular housing 22, a rubber member 23 and a cover 24.

### (Configuration of Reed Switch Subunit 21)

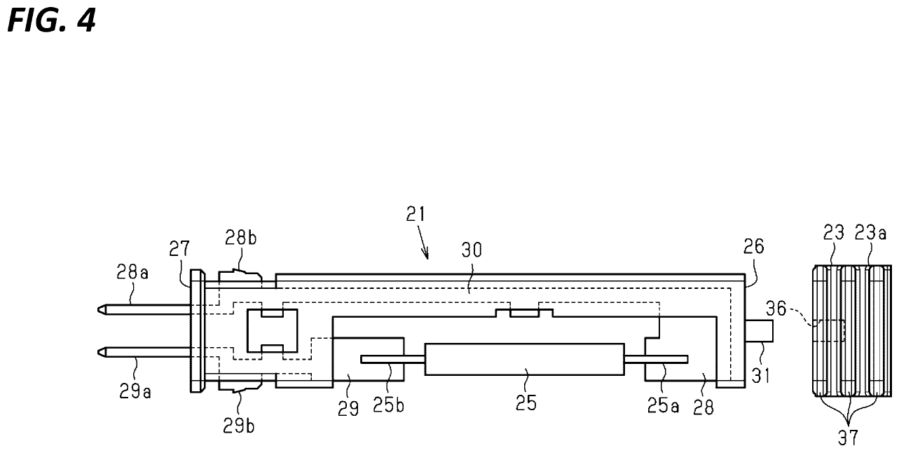

As shown in FIGS. 3 and 4, the reed switch subunit 21 includes a reed switch 25 and has a first end part 26 and a second end part 27 in a length direction.

For example, the reed switch 25 includes a pair of ferromagnetic blades accommodated in a glass tube and the pair of ferromagnetic blades are switched to a connected state and a non-connected state (blocked state) according to a magnetic field. The reed switch 25 includes a first switch terminal 25a and a second switch terminal 25b projecting outward from both ends of the glass tube.

Further, the reed switch subunit 21 of this embodiment includes a first terminal 28, a second terminal 29 and a base portion 30. The first and second terminals 28, 29 are insert-molded in the base portion 30 made of resin. The first terminal 28 is connected to the first switch terminal 25a. The first terminal 28 includes a first external terminal 28a projecting outward from the second end part 27 to be exposed in the base portion 30. The second terminal 29 is connected to the second switch terminal 25b. The second terminal 29 includes a second external terminal 29a projecting outward from the second end part 27 to be exposed in the base portion 30. The first and second external terminals 28a, 29a project in parallel.

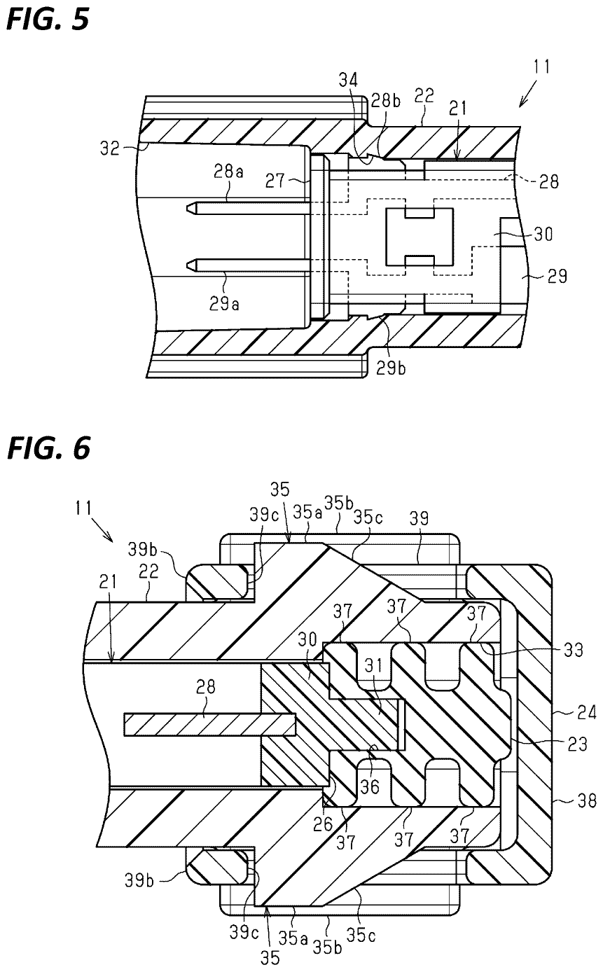

Further, as shown in FIGS. 4 and 5, the first terminal 28 includes a first locking portion 28b projecting outward in a width direction of the base portion 30 to be exposed on the second end part 27 side. Further, the second terminal 29 includes a second locking portion 29b projecting outward in the width direction of the base portion 30 to be exposed on the second end part 27 side. The first and second locking portions 28b, 29b project in directions separating from each other, which are opposite directions along the width direction of the base portion 30. The first and second locking portions 28b, 29b are formed into such a claw shape as to increase a projecting amount toward the second end part 27.

Further, as shown in FIG. 4, the first end part 26 includes a supporting protrusion 31 projecting in the length direction of the reed switch subunit 21 in the base portion 30. The supporting protrusion 31 of this embodiment is formed into a cylindrical shape. The supporting protrusion 31 is provided in a center in the width direction of the base portion 30. Further, the supporting protrusion 31 is provided in a center in a height direction of the base portion 30 (see FIG. 6).

### (Configuration of Housing 22)

As shown in FIG. 3, the housing 22 is in the form of a rectangular tube capable of accommodating and holding the reed switch subunit 21. The housing 22 of this embodiment is in the form of a rectangular tube having a rectangular shape when viewed from the length direction of the housing 22. The housing 22 includes a first opening 32, through which the reed switch subunit 21 is insertable with the first end part 26 in the lead. The first opening 32 is so formed that an external connector electrically connected to an unillustrated controller is fittable thereinto. Further, the housing 22 includes a second opening 33 on a side opposite to the first opening 32. Note that the second opening 33 is formed into a rectangular shape longer in the width direction than in the height direction when viewed from an opening direction of the second opening 33.

As shown in FIG. 5, a supporting portion 34 is provided on the inner surface of the housing 22 at a position near the first opening 32. The supporting portion 34 supports the second end part 27 side of the reed switch subunit 21 with the reed switch subunit 21 inserted in the housing 22. For example, the supporting portion 34 supports the second end part 27 side of the reed switch subunit 21 by the first and second locking portions 28b, 29b biting into the supporting portion 34 with the reed switch subunit 21 inserted in the housing 22. Note that the supporting portion 34 is a wall surface set such that the first and second locking portions 28b, 29b bite thereinto when the reed switch subunit 21 is inserted into the housing 22. The supporting portion 34 is deformed to be scraped by the first and second locking portions 28b, 29b when the reed switch subunit 21 is inserted into the housing 22. Note that FIG. 5 schematically shows a state where the first and second locking portions 28b, 29b are biting in the supporting portion 34.

Further, as shown in FIG. 3, fixing portions 35 are provided on the outer surface of the housing 22 at positions near the second opening 33. The fixing portions 35 are provided on both surfaces in the height direction of the housing 22. The fixing portion 35 of this embodiment includes a locking projection 35a provided in a center in the width direction of the housing 22 and a pair of guiding projections 35b provided at positions across the locking projection 35a in the width direction of the housing 22. The locking projection 35a has an inclined surface 35c, a projecting amount of which increases toward a central side in the length direction of the housing 22. The pair of guiding projections 35b project with a fixed projecting amount and extend in parallel along the length direction of the housing 22.

### (Configuration of Rubber Member 23)

As shown in FIGS. 3 and 6, the rubber member 23 is formed into a rectangular parallelepiped shape. The rubber member 23 has a rectangular shape longer in the width direction than in the height direction when viewed from the opening direction of the second opening 33. The rubber member 23 stops water at the second opening 33 by being fit into the second opening 33, and supports the first end part 26 of the reed switch subunit 21. For example, the rubber member 23 includes a supporting recess 36, into which the supporting protrusion 31 is fit. The supporting recess 36 has a circular inner peripheral surface so that the outer peripheral surface of the cylindrical supporting protrusion 31 is held in close contact with the supporting protrusion 31.

Further, the rubber member 23 includes a plurality of projecting portions 37 in the length direction of the reed switch subunit 21 for locally pressing and contacting the second opening 33. For example, the projecting portions 37 are provided on both surfaces in the height direction of the rubber member 23. In other words, the projecting portions 37 respectively project from the both surfaces in the height direction of the rubber member 23. Further, the projecting portions 37 are provided on the entire rubber member 23 in the width direction. In other words, the projecting portions 37 project with a uniform height over the entire rubber member 23 in the width direction. Three projecting portions 37 are provided at equal intervals in the length direction of the rubber member 23. Further, both surfaces in the width direction of the rubber member 23 are flat surfaces 23a continuous in the length direction of the rubber member 23 since the projecting portions 37 are not provided.

### (Configuration of Cover 24)

As shown in FIGS. 3 and 6, the cover 24 hinders the detachment of the rubber member 23 from the second opening 33 by being fixed on the second opening 33 side of the housing 22. For example, the cover 24 includes a plate portion 38 in the form of a rectangular plate for covering the second opening 33 and a tube portion 39 having a tubular shape extending to cover the outer periphery of the housing 22 from the outer edge of the plate portion 38. The tube portion 39 includes a pair of slits 39a, into which the pair of guiding projections 35b are fit, and locking pieces 39b each deflectable in the height direction between the pair of slits 39a. The locking piece 39b includes a locking hole 39c, into which the locking projection 35a is fit. The cover 24 is assembled with the housing 22 by being moved relative to the housing 22 along the length direction of the housing 22. A moving direction of the cover 24 is first guided by the guiding projections 35b fit into the slits 39 when the cover 24 is assembled. Then, when the cover 24 is assembled, the locking pieces 39b are deflected to ride over the inclined surfaces 35c of the locking projections 35a, and the assembly is completed by fitting the locking projections 35a into the locking holes 39c. That is, the cover 24 is fixed to the housing 22 by fitting the guiding projections 35b into the slits 39a and fitting the locking projections 35a into the locking holes 39c.

Next, functions of the reed switch unit 11 configured as described above are described.

For example, if the liquid 12 stored in the reservoir tank 13 is reduced, the permanent magnet 16 moves downward together with the float 14. When the permanent magnet 16 approaches the reed switch unit 11, the reed switch 25 is switched to the connected state. Then, a reduction of the liquid 12 is detection by the unillustrated controller connected to the first and second external terminals 28a, 28a.

Next, effects of the above embodiment are described below.

(1) The second end part 27 side of the reed switch subunit 21 is supported on the first opening 32 side in the housing 22, and the first end part 26 thereof is supported by the rubber member 23 fit into the second opening 33. Thus, the rattling of the reed switch 25 together with the rattling of the reed switch subunit 21 with respect to the housing 22 is suppressed. In this way, for example, the reed switch unit 11 can detect a change of a magnetic field such as an approach of the permanent magnet 16 with high accuracy. For example, such erroneous determination of the controller to determine that the amount of the liquid 12 has exceeded a threshold value in a state before the amount of the liquid exceeds the threshold value can be suppressed. Further, since water is stopped at the second opening 33 by the rubber member 23, the reed switch subunit 21 is prevented from being wetted with water. Further, since the rubber member 23, i.e. one member, has a function of supporting the first end part 26 of the reed switch subunit 21 and a function of stopping water at the second opening 33, an increase in the number of components is, for example, suppressed.

(2) The first end part 26 includes the supporting protrusion 31 projecting in the length direction of the reed switch subunit 21, and the rubber member 23 includes the supporting recess 36, into which the supporting protrusion 31 is fit. Thus, the rattling of the first end part 26 in a direction intersecting the length direction of the reed switch subunit 21 is satisfactorily suppressed.

(3) Since the supporting protrusion 31 has a cylindrical shape, the rattling of the first end part 26 in all directions intersecting the length direction of the reed switch subunit 21 is satisfactorily suppressed. That is, since having a cylindrical shape, the supporting protrusion 31 can be supported in the supporting recess 36 of the rubber member 23 equally in all the directions intersecting the length direction of the reed switch subunit 21. Therefore, rattling in all the directions is satisfactorily suppressed.

(4) The rubber member 23 includes the plurality of projecting portions 37 in the length direction of the reed switch subunit 21 for locally pressing and contacting the second opening. Thus, the mountability of the rubber member 23 into the second opening 33 is improved and the water stopping property of the second opening 33 is improved. That is, if the rubber member 23 is, for example, shaped to press and contact the second opening 33 by one continuous surface without including the projecting portions 37, friction resistance in fitting the rubber member 23 into the second opening 33 increases. This can be avoided. Further, if the rubber member 23 is, for example, shaped to press and contact the second opening 33 by one continuous surface without including the projecting portions 37, there is a possibility that the water stopping property cannot be maintained due to partial distortion or the like. However, this can be avoided.

(5) Since the projecting portions 37 are provided on the both surfaces in the height direction of the rubber member 23 and provided in the width direction over the entire rubber member 23 longer in the width direction than in the height direction, the mountability of the rubber member 23 into the second opening 33 is more improved and the water stopping property of the second opening 33 is more improved. That is, better effects can be obtained, for example, as compared to a configuration in which the projecting portions 37 are provided on both surfaces in the width direction of the rubber member 23 and provided in the height direction over the entire rubber member 23 shorter in the height direction than in the width direction.

(6) Since the cover 24 is provided to hinder the detachment of the rubber member 23 from the second opening 33, the detachment of the rubber member 23 fit in the second opening 33 from the second opening 33, for example, due to vibration or the like is hindered.

This embodiment can be modified and carried out as follows. This embodiment and the following modifications can be carried out in combination without technically contradicting each other.

Although the first end part 26 includes the supporting protrusion 31 and the rubber member 23 includes the supporting recess 36, into which the supporting protrusion 31 is fit, in the above embodiment, there is no limitation to this and another configuration may be adopted if the rubber member 23 can support the first end part 26. For example, without including the supporting protrusion 31 and the supporting recess 36, the rubber member 23 may be configured to support the first end part 26 by a friction force given by the rubber member 23 pressing and contacting the first end part 26.

Although the supporting protrusion 31 has a cylindrical shape in the above embodiment, there is no limitation to this and another shape may be adopted. For example, the supporting protrusion 31 may have a rectangular column shape. Note that, of course, the shape of the supporting recess 36 may be changed according to the shape of the supporting protrusion 31.

Although the rubber member 23 includes the plurality of projecting portions 37 for locally pressing and contacting the second opening 33 in the above embodiment, there is no limitation to this and the projecting portions 37 may not be provided.

Although the projecting portions 37 are provided on the both surfaces in the height direction of the rubber member 23 in the above embodiment, there is no limitation to this and the projecting portions 37 may be provided on only one surface in the height direction of the rubber member 23. Further, the projecting portions 37 may be provided on both surfaces in the width direction or may be provided on only one surface in the width direction. Further, the projecting portions 37 may be provided on the both surfaces in the height direction of the rubber member 23 and on the both surfaces in the width direction.

Although the projecting portions 37 are provided entirely in the width direction in the above embodiment, there is no limitation to this and the projecting portions 37 may be provided at positions on both sides in the width direction or may be provided only at middle positions in the width direction.

Although three projecting portions 37 are provided at equal intervals in the length direction of the rubber member 23 in the above embodiment, there is no limitation to this and the projecting portions 37 may be, for example, provided at unequal intervals or two, four or more projecting portions 37 may be provided.

Although the reed switch unit 11 includes the cover 24 for hindering the detachment of the rubber member 23 from the second opening 33 in the above embodiment, there is no limitation to this and the cover 24 may not be provided. Note that, in this case, the housing 22 is, for example, preferably provided with a projecting portion or the like for suppressing the detachment of the rubber member 23. By doing so, the number of components of the reed switch unit 11 can be reduced.

Although the second end part 27 side of the reed switch subunit 21 is supported in the supporting portion 34 by the first and second locking portions 28b, 29b biting into the supporting portion 34 in the above embodiment, the second end part 27 side may be supported by another configuration.

Although the housing 22 is in the form of a rectangular tube in the above embodiment, there is no limitation to this and another shape may be adopted if the housing 22 can accommodate and hold the reed switch subunit 21. For example, the shape of the housing 22 may be changed to a hollow cylindrical shape.

Although the cover 24 is fixed to the housing 22 by fitting the guiding projections 35b into the slits 39a and fitting the locking projections 35a into the locking holes 39c in the above embodiment, there is no limitation to this and the cover 24 may be fixed to the housing 22 by another configuration. For example, the cover 24 may be fixed to the housing 22 by screws.

Although the housing 22 is a dedicated component provided in the reed switch unit 11 in the above embodiment, there is no limitation to this and the housing 22 may be, for example, a component integrally molded with the reservoir tank 13.

Although the reed switch unit 11 is for detecting the amount of the liquid 12 stored in the reservoir tank 13 in the above embodiment, there is no limitation to this and the reed switch unit 11 may be used in another device.

The rubber member 23 of the shown embodiment is a resilient element for directly contacting distal ends of the housing 22 and the base portion 30. For example, when the reed switch unit 11 and/or the reservoir tank 13 receive(s) external vibration, the rubber member 23 can at least partially or preferably completely absorb or attenuate that external vibration and, therefore, is advantageous in suppressing the vibration or displacement of the distal end of the base portion 30 and the reed switch 25 with respect to the housing 22. As shown in FIG. 6, a gap may be formed between the radially outward facing surface of the base portion 30 and the radially inward facing surface of the housing 22 at a distal side of the base portion 30 by the rubber member 23, and the base portion 30 may be kept out of contact with the housing 22 at the distal side of the base portion 30.

The reservoir tank 13 of the shown embodiment may be referred to as a liquid tank. The reservoir tank 13 may be, for example, a vehicle liquid tank and can be used together with vibration generating sources such as an engine, a motor and tires for travel. An assembly of the float 14 and the permanent magnet 16 of the shown embodiment may be referred to as a magnetic float. The reed switch unit 11 of the shown embodiment may be referred to as a reed switch-type liquid level sensor used together with a liquid tank and a magnetic float. The first and second external terminals 28a, 29a of the reed switch subunit 21 of the shown embodiment may be referred to as electrical connector terminals. The second end part 27 of the reed switch subunit 21 of the shown embodiment may be referred to as a proximal end of the base portion 30. The first end part 26 of the reed switch subunit 21 of the shown embodiment may be referred to as a distal end of the base portion 30. A subset of the housing 22, the rubber member 23 and the cover 24 of the shown embodiment may be referred to as an enclosure configured to be retrofit to the liquid tank. The housing 22 of the shown embodiment may be referred to as a straight tube housing for accommodating the base portion 30 and the reed switch 25 or a straight tube part of the enclosure. The rubber member 23 of the shown embodiment may be referred to as a distal end resilient plug configured to be retrofit to a radially inner side of a distal side tubular part of the housing 22 from a distal side of the housing 22 and position the distal end of the base portion 30 with respect to the housing 22 in the length direction and the radial direction by directly contacting the distal ends of the housing 22 and the base portion 30. The cover 24 of the shown embodiment may be referred to as a distal side cap to be retrofit to a radially outer side of the distal side tubular part of the housing from the distal side of the housing 22 to cover the distal end rubber plug (23).

One aspect of the present disclosure is directed to a reed switch-type liquid level sensor used together with a liquid tank and a magnetic float, the reed switch-type liquid level sensor being provided with:
an elongated base portion having a proximal end including an electrical connector terminal and a distal end;
a linear reed switch fixedly supported in the elongated base portion to extend between the proximal end and the distal end of the elongated base portion; and
an enclosure including a straight tube part for accommodating the elongated base portion and the reed switch and configured to be retrofit to the liquid tank,
the straight tube part of the enclosure including a proximal side tubular part including a proximal opening for covering the proximal end of the elongated base portion and a distal side tubular part including a distal opening for covering the distal end of the elongated base portion, and
the enclosure including a distal end resilient plug configured to be retrofit to a radially inner side of the distal end tubular part of the straight tube part from the distal side of the straight tube part and position the distal end of the elongated base portion with respect to the straight tube part in a length direction and a radial direction by directly contacting the distal side tubular part of the straight tube part and the distal end of the elongated base portion.

The enclosure can include a distal side cap to be retrofit to a radially outer side of the distal side tubular part of the straight tube part from the distal side of the straight tube part to cover the distal end resilient plug.

### LIST OF REFERENCE NUMERALS

11 reed switch unit
12 liquid
13 reservoir tank
14 float
15 rail
16 permanent magnet
17 unit holding portion
21 reed switch subunit
22 housing
23 rubber member
23a flat surface
24 cover
25 reed switch
25a first switch terminal
25b second switch terminal
26 first end part
27 second end part
28 first terminal
28a first external terminal
28b first locking portion
29 second terminal
29a second external terminal
29b second locking portion
30 base portion
31 supporting protrusion
32 first opening
33 second opening
34 supporting portion
35 fixing portion
35a locking projection
35b guiding projection
35c inclined surface
36 supporting recess
37 projecting portion
38 plate portion
39 tube portion
39a slit
39b locking piece
39c locking hole

1. A reed switch unit, comprising:
an elongated reed switch subunit including a reed switch and having a first end part and a second end part in a length direction; and
a tubular housing including a first opening, the reed switch subunit being insertable into the first opening with the first end part side in the lead, the housing accommodating and holding the reed switch subunit,
the second end part side of the reed switch subunit being supported on the first opening side in the housing,
the housing including a second opening on a side opposite to the first opening; and
the reed switch unit comprising a rubber member for stopping water at the second opening by being fit into the second opening, the rubber member supporting the first end part of the reed switch subunit.

2. The reed switch unit of claim 1, wherein:
the first end part includes a supporting protrusion projecting in the length direction of the reed switch subunit, and
the rubber member includes a supporting recess, the supporting protrusion being fit into the supporting recess.

3. The reed switch unit of claim 2, wherein the supporting protrusion has a cylindrical shape.

4. The reed switch unit of claim 1, wherein the rubber member includes a plurality of projecting portions in the length direction of the reed switch subunit for locally pressing and contacting the second opening.

5. The reed switch unit of claim 4, wherein:
the second opening has a rectangular shape longer in a width direction than in a height direction when viewed from an opening direction of the second opening,
the rubber member has a rectangular shape longer in the width direction than in the height direction when viewed from the opening direction of the second opening, and
the projecting portions are provided on both surfaces in the height direction of the rubber member and provided over the entire rubber member in the width direction.

6. The reed switch unit of claim 1, comprising a cover for hindering detachment of the rubber member from the second opening.
